(19) United States
(12) Patent Application Publication
(10) Pub. No.: US 2015/0125583 A1
(43) Pub. Date: May 7, 2015

(54) Method and Apparatus for Sorting Grain

(71) Applicant: Bühler AG, Uzwil (CH)

(72) Inventors: Detlef Blass, Bad Harzburg (DE); Michael W. Stephens, Jonesboro, AK (US)

(21) Appl. No.: 14/405,296

(22) PCT Filed: Jun. 4, 2013
(86) PCT No.: PCT/EP2013/061462

§ 371 Date: Dec. 3, 2014

(30) Foreign Application Priority Data
Jun. 5, 2012 (EP) 12170814.3

(51) Int. Cl. B07C 5/342; B02B 3/00; B02B 5/02; B07C 5/12

(52) U.S. Cl. CPC B07C 5/3425; B07C 5/12; B02B 3/00; B02B 5/02
USPC 426/482; 209/44.1; 209/10; 209/44.2; 209/44.3; 99/601

(57) ABSTRACT

The method for sorting grain (10) comprises the step of conveying the grain (10) with at least a part of the pericarp, seed-coat or aleuron layer or any combination thereof attached into a colour-sorting device (1). The grain (10) is sorted according to colour into at least a first colour-fraction (11) and at least a second colour-fraction (12). The first colour-fraction (11) or the second colour-fraction (12) is conveyed into a size-sorting device (2). Subsequently, the first colour-fraction (11) or the second colour-fraction (12) conveyed into the size-sorting device (2) is sorted according to size of the grain (10) into a size-accept fraction (13) and a size-reject fraction (14).

The present invention is related to a method for sorting grain and an apparatus for carrying out the method according to the preamble of the independent claims.

It is known in the art as e.g. disclosed in U.S. Pat. No. 4,179,363 to separate a mixture of hulled and unhulled grain by feeding the mixture into an oscillating table separator for separating the mixture depending on the different elasticities of the hulled and unhulled grain.

It is further known in the art as e.g. disclosed in U.S. Pat. No. 5,733,592 to separate grain according to colour with an optical sorting device.

The demand in industry however requires nowadays that the through-put through these sorting devices and the yield of the sorting process are increased. In the known devices it is furthermore possible that the sorting process is not accurate enough such that hulled grain are classed as unhulled grain and subsequently conveyed with the unhulled grain for further processing like a further hulling step, which could damage the hulled grain thus reducing the through-put through the sorting device and the yield of the sorting.

It is furthermore a requirement nowadays to reduce the dynamic load generated by the oscillations of the sorting device on the supporting structure the sorting device is supported by, e.g. a building.

It is thus an object of the present invention to overcome the above-mentioned drawbacks, in particular to provide a method and an apparatus for sorting grain which allows for a higher through-put of grain to be sorted through the sorting device and which achieves a higher yield of accepted grain. It is a further object of the present invention to provide an apparatus which decreases the dynamic load exerted on the structure the sorting device is supported by.

These objects are met by the method and apparatus according to the independent claims.

The method for sorting grain comprises the step of conveying the grain with at least a part of the pericarp, seed-coat or aleurone layer or any combination thereof attached into a colour-sorting device. In particular, rice is used as grain. In particular, the grain has substantially the complete pericarp, seed-coat or aleurone layer or any combination thereof attached. The grain is sorted according to colour into at least a first colour-fraction and at least a second colour-fraction. The first colour-fraction or the second colour-fraction is conveyed into a size-sorting device. In other words, either the first colour-fraction or the second colour-fraction is conveyed into the size-sorting device. Subsequently, the first colour-fraction or the second colour-fraction conveyed into the size-sorting device is sorted according to size of the grain into a size-accept fraction and a size-reject fraction. The steps of conveying the grain, sorting the grain, conveying the first colour-fraction or the second colour-fraction and the sorting according to size are to be executed in the listed order. In particular, the sorting according to size is carried out depending on the thickness of the grain.

In the context of the present invention, the term “grain” means any grain comprising a pericarp, seed-coat or aleurone layer or any combination thereof, in particular rice, pea, lentil, buckwheat, oat and sunflower seeds as well as any combination thereof.

The term “colour-sorting” has the meaning in the context of the present invention that the grain is sorted according to colour which is detected e.g. with an optical sensor. In particular, colour-sorting has the meaning of optical colour-sorting. Such a colour sorting can be performed with known optical sorting machines as e.g. supplied by Buhler AG under the name “Sortex M”.

In the context of the present invention, the term “pericarp, seed-coat or aleurone layer or any combination thereof” is to be understood as being a part of the outer layer of grain after hulling. For instance, rice comprises the hull which envelops a fruit, e.g. brown rice; the fruit comprises the outer layers pericarp, seed-coat and aleurone layer; the outer layers envelop the germ and the endosperm.

The term “substantially the complete pericarp, seed-coat or aleurone layer or any combination thereof” has the meaning in the context of the present invention that, in case of unintentional removal of a part of the pericarp, seed-coat or aleurone layer or any combination thereof from the grain in a hulling process, the grain is regarded as grain comprising substantially the complete pericarp, seed-coat or aleurone layer or any combination thereof. In particular, grain comprising at least 90% and preferably at least 95% of the pericarp, seed-coat or aleurone layer or any combination thereof is to be understood as grain comprising substantially the complete pericarp, seed-coat or aleurone layer or any combination thereof.

In the context of the present invention the size of grain has the meaning of the grain having a length and a thickness. The length of a grain is constituted by the longest dimension of the grain and the thickness of the grain is constituted by the largest dimension of a projection of the grain along the length of the grain onto a surface perpendicular to the length. If the grain is for example shaped as an ellipsoid, the longest dimension of the ellipsoid constitutes the length; a projection along the length onto a surface perpendicular to the protection results in an ellipse; the longest dimension of said ellipse is the thickness of the grain.

The sorting of grain according to size can be performed with conventional means known in the art like sieves that vibrate. In particular, drum grader are used to sort the grain according to thickness where a drum exhibiting a sievelike wall structure is rotating thus achieving a sorting of the grain according to thickness; such a drum grader is known in the art as disclosed in IN 01077MU2002 A and e.g. available from Buhler AG under the name “Rotosort”.

The method for sorting grain has the advantage that, due to the colour-sorting, at least two fractions can be formed, wherein a first colour-fraction comprises grain which is acceptable for further processing like e.g. producing rice for human consumption. The second colour-fraction, however, may contain grain that has to be treated again e.g. by a further hulling step before it is ready for human consumption. Furthermore, said second colour-fraction may also contain grain which would be ready for human consumption but exhibits a colour e.g. similar to an unhulled grain. With the sorting step according to size, in particular thickness, the grain acceptable for human consumption having a colour similar to e.g. unhulled grain can be separated from the grain needing further treatment like a further hulling step because the acceptable grain exhibit a size and in particular thickness different from the e.g. unhulled grain. This has the advantage that only grain needing further treatment is optionally conveyed into a further treatment process, wherein the grain acceptable for human consumption having the wrong colour can be separated, thus preventing said further treatment of said grain which can damage the grain. Compared to the methods known in the art, this method has the advantage of increasing the head rice yield by 1-3%.

Furthermore, the through-put of grain through the sorting device can be increased by a factor of up to 2 with an apparatus according to the invention occupying e.g. a similar factory-space as certain conventional sorting machines.

Furthermore, since no oscillating sorting tables are necessary in particular when using a drum grader, the dynamic load exerted on the support the apparatus rests upon is significantly reduced compared to known apparatuses.

Preferably, the size-accept fraction is combined with the first colour-fraction or the second colour-fraction not conveyed into the size-sorting device for forming a further accept-fraction for further processing. In other words, the size-accept fraction is either combined with the first colour-fraction or the second colour-fraction depending on which of the first colour-fraction or second colour-fraction is conveyed into the size-sorting device.

This has the advantage that the grain acceptable for further processing according to colour and/or size can be combined, which makes the processing of the further accept-fraction more efficient because only one flow of grain has to be processed and no unnecessary treatment of the size-accept fraction is performed.

More preferably, the size-reject fraction exhibits a thickness larger than the size-accept fraction.

In particular, this is the case for the difference between hulled grain and unhulled grain wherein the size-reject fraction comprises substantially the unhulled grain and the size-accept fraction substantially the hulled grain. This has the advantage that this criterion allows for a simple separation method of hulled and unhulled grain in particular with a drum grader.

Even more preferably, the method comprises a step of cleaning unsorted grain comprising contaminants and grain in a cleaning device by separating contaminants from grain before the step of conveying the grain into a colour-sorting device.

In the context of the present invention, the term “contaminants” comprises dirt, husks, hulls and other particles mixed with grain. Unsorted grain comprises grain and contaminants.

This has the advantage of improving the reliability and efficiency of the colour-sorting of grain in the colour-sorting device, because the cleaned grain produces fewer false-negative signals, i.e. a false reject signal, in the colour-sorting device which leads to fewer rejected grain due to the false-negative signals thus increasing the through-put and the head rice yield.

The separation in the colour-sorting device is often done with short pulses of air generated depending on the determined colour of the grain. The generator used to generate the pulses of air for separation exhibits a service life which can be increased by cleaning the grain before it is conveyed into the colour-sorting device, because this reduces the number of required pulses of air per unit of time with cleaned grain compared to unsorted grain.

Preferably, the cleaning step is carried out in a cleaning device formed as an air-separation device.

In the context of the present invention, the term “air-separation device” means the separation of grain according to size and/or specific weight with a stream of air. Such devices are known in the art as e.g. disclosed in EP 0 178 316 B1 and available e.g. from Buhler AG under the name “air-recycling aspirator”. Such a device usually works by conveying a mixture of particles into a stream of air, wherein particles with a smaller size and/or larger specific weight fall due to the pull of gravity to a first outlet and the other particles exhibiting a larger size and/or smaller specific weight are conveyed by the stream of air to a second outlet.

The use of such an air-separation device has the advantage of reliably separating the unsorted grain into contaminants and grain, and the air-separation device only produces a small dynamic load on the supporting structure, because such a device only comprises few oscillating parts. Furthermore, such a device can be operated in an energy efficient way.

More preferably, the method comprises the step of hulling raw grain before conveying the grain into the colour-sorting device.

Even more preferably, the raw grain is hulled before the cleaning of the unsorted grain.

In the context of the present invention, the term “raw grain” means grain that is fed into a hulling device.

The step of hulling raw grain before cleaning has the advantage that husks, hulls and other contaminants can be separated in the cleaning step thus making the colour-sorting step more reliable as explained above.

Preferably, the method comprises the step of conveying the size-reject fraction into the hulling device.

In the context of the present invention, the term “hulling device” means a device for hulling grain. Such devices are known in the art as e.g. disclosed in WO 2006/002555 A1 and are e.g. available from Buhler AG under the name “top husk”.

This has the advantage that the size-reject fraction, which constitutes substantially the unhulled fraction after colour sorting and size sorting, does not have to be discarded and can be hulled in the hulling device, such that after a subsequent colour sorting and/or size sorting the grain resulting from the size-reject fraction can be used for further processing. Hence, the head rice yield can be increased. This conveyance of the size-reject fraction into the hulling device has the further advantage that the grain can be circulated thus requiring fewer equipment. This reduces the cost and the energy consumption of the apparatus necessary for carrying out the method.

A further advantage is that less grain has to be circulated back into the hulling device due to the sorting step, which results in a higher through-put of the method.

A further aspect of the present invention is an apparatus for carrying out the method as explained above. The apparatus comprises a colour-sorting device for sorting grain according to colour into at least a first colour-fraction and at least a second colour-fraction. In flow direction of the grain downstream of the colour-sorting device, the apparatus comprises a size-sorting device for sorting colour-sorted grain according to size into at least a size-accept fraction and a size-reject fraction. A cleaning device for cleaning unsorted grain is arranged upstream of the colour-sorting device.

In particular, the grain is conveyed directly without further treatment into the colour-sorting device, e.g. by gravity and/or with conveyance means.

This apparatus has the advantages as already described for the method for sorting grain above.

Preferably, the size-sorting device is formed as a thickness-sorting device, in particular a drum grader.

More preferably, a cleaning device for the cleaning of unsorted grain is arranged upstream of the colour-sorting device.

Preferably, the cleaning device is formed as an air-separation device for separation of unsorted grain at least into grain and contaminants.

More preferably, a hulling device for hulling of raw grain is arranged upstream of a colour-sorting device and in particular upstream of the cleaning device.

Even more preferably, the apparatus comprises conveyance means for conveying at least the size-reject fraction into the hulling device. In particular, the first colour-fraction or the second colour-fraction not conveyed into the size-sorting device is conveyable into the hulling device with the conveyance means.

In particular, conveyance means are formed as at least one of the following devices or any combination thereof: spout, chute, elevator, conveyor belt, trough chain conveyor.

Preferably, the apparatus comprises further conveyance means for combining at least the size-accept fraction with the first colour-fraction or the second colour-fraction not conveyed into the size-sorting device into a further accept-fraction for further processing.

A further aspect of the present invention is directed to a method for upgrading an apparatus comprising a colour-sorting device for sorting grain according to colour and a size-sorting device for sorting colour-sorted grain according to size. The size-sorting device is arranged in flow direction of the grain downstream of the colour-sorting device. The method comprises the step of arranging a cleaning device for cleaning unsorted grain upstream of the colour-sorting device. In particular, an apparatus as described above is formed, in particular for performing a method as described above.

This has the advantages as already described for the apparatus and method described above.

Further objects, advantages and novel features according to the invention will become apparent from the following detailed description of the preferred embodiments, without limiting the present invention to these embodiments. The drawings depict:

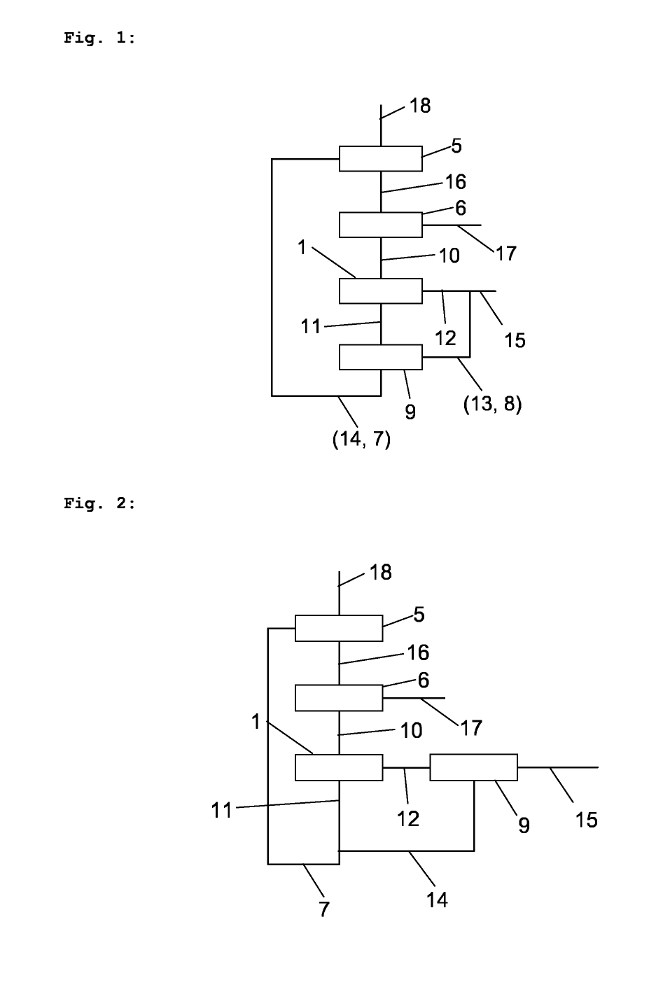

FIG. 1: Schematic view of an apparatus according to the invention for processing rice;

FIG. 2: schematic view of a further apparatus according to the invention for processing peas;

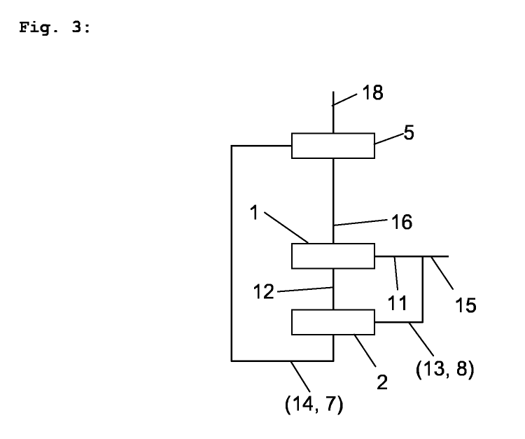

FIG. 3: schematic view of an alternative apparatus according to the invention without a cleaning device for processing buckwheat.

FIG. 1 shows an apparatus according to the invention for sorting rice.

Raw grain 18 is fed into a hulling device for hulling the unhulled grain comprised in a raw grain 18. After hulling in the hulling device 5, the unsorted grain 16 comprising grain 10 and contaminants like hulls from the hulling step in the hulling device 5 is conveyed into an air-separation device 6. The contaminants 17 are separated from the grain 10 and conveyed out of the apparatus.

The grain 10 comprising 95% of the pericarp and 100% of the seed-coat and aleurone layer is subsequently conveyed into colour-sorting device 1 for sorting the grain 10 into a first colour-fraction 11 and a second colour-fraction 12.

The second colour-fraction 12 comprises substantially the hulled rice which is ready for human consumption. The first colour-fraction 11 is subsequently conveyed into a drum grader 9 for separating the grain 10 comprised in the first colour-fraction according to size. A size-accept fraction 13 comprising the rice that is already hulled but was due to its colour classed as unhulled rice by the colour-sorting device 1 is conveyed out of the drum grader 9 with further conveyance means 8 and combined with the second colour-fraction 12 into a further accept-fraction 15 for further processing like polishing.

A size-reject fraction 14 comprising substantially unhulled rice is conveyed with conveyance means 7 back into the hulling device 5.

The conveyance means 7 is formed as a spout and the further conveyance means 8 is formed as an elevator.

From hereon and henceforth, parts with the same reference numeral denominate the same parts throughout all the figures.

FIG. 2 shows a schematic view of an apparatus for sorting peas. Said apparatus comprises in flow direction a hulling device 5, an air-separation device 6, a colour-sorting device 1 and a drum grader 9.

The apparatus shown in FIG. 2 differs from the apparatus according to FIG. 1 by the different arrangement of the drum grader 9. Since peas differ in colour from rice, the second colour-fraction 12 comprises the hulled peas and split, wherein the first colour-fraction 11 comprises the unhulled peas. In the drum grader 9, the hulled peas and the split are separated inter alia from unhulled peas which are conveyed as the size-reject fraction 14 with conveyance means 7 back into the hulling device 5. The further accept-fraction 15 comprises the hulled peas and split.

In the context of the present invention, split from grain, in particular from peas and/or lentils, is formed by splitting the grain during processing, in particular hulling, into at least two parts. In particular split does not comprise the hull.

The grain 10 comprises 95% of the pericarp.

FIG. 3 shows an alternative apparatus according to the present invention for sorting buckwheat.

The raw grain 18, i.e. the unhulled buckwheat is conveyed into a hulling device 5 for hulling the raw grain 18. The raw grain 18 treated in the hulling device 5 is converted into unsorted grain 16 which comprises the grain and contaminants.

After hulling, the unsorted grain 16 is conveyed into a colour-sorting device 1 for sorting the unsorted grain 16 into a first colour-fraction 11 and a second colour-fraction 12. The first colour-fraction 11 comprises substantially the fraction acceptable for human consumption, which is conveyed out of the apparatus.

The second colour-fraction 12 substantially comprises the unhulled grain that is conveyed into a size-sorting device 2. The size-sorting device 2 is formed as an oscillating sieve, e.g. a plan sifter.

The size-accept fraction 13 is conveyed out of the size-sorting device 2 by further conveyance means 8 formed as a chute and combined with the first colour-fraction 11 into a further accept-fraction 15 acceptable for human consumption for further processing if necessary.

The size-reject fraction 14 is conveyed by conveyance means 7 formed as a trough chain conveyor.

1. A method for sorting grain (10), in particular rice, comprising the steps:
(i) Conveying the grain (10) with at least a part of the pericarp, seed-coat or aleurone layer or any combination thereof attached, in particular substantially the complete pericarp, seed-coat or aleurone layer or any combination thereof attached, into a colour-sorting device (1);
(ii) Sorting the grain (10) according to colour into at least a first colour-fraction (11) and at least a second colour-fraction (12);
characterized by
(iii) Conveying the first colour-fraction (11) or the second colour-fraction (12) into a size-sorting device (2);
(iv) Sorting the first colour-fraction (11) or the second colour-fraction (12) conveyed into the size-sorting device (2) according to size, in particular thickness, of the grain (10) into a size-accept fraction (13) and a size-reject fraction (14).

2. The method according to claim 1, comprising the step of combining the size-accept fraction (13) with the first colour-fraction (11) or the second colour-fraction (12) not conveyed into the size-sorting device (2) into a further accept-fraction (15) for further processing.

3. The method according to claim 1 or 2, wherein the size-reject fraction (14) exhibits a thickness larger than the size-accept fraction (13).

4. The method according to one of claims 1 to 3, comprising the step of cleaning unsorted grain (16) comprising contaminants (17) and grain (10) in a cleaning device (3) by separating contaminants (17) from grain (10) before step (i).

5. The method according to claim 4, wherein the cleaning step is carried out in a cleaning device (3) formed as an air-separation device (6).

6. The method according to one of claims 1 to 5, comprising the step of hulling raw grain (18) before step (i) in a hulling device (5).

7. The method according to claim 6, wherein raw grain (18) is hulled before the cleaning of the unsorted grain (16).

8. The method according to claim 7, comprising the step of conveying the size-reject fraction (14) into the hulling device (5).

9. An apparatus for carrying out the method according to any of the preceding claims, comprising a colour-sorting device (1) for sorting grain (10) according to colour into at least a first colour-fraction (11) and at least a second colour-fraction (12), wherein a size-sorting device (2) for sorting colour-sorted grain (19) according to size into at least a size-accept fraction (13) and a size-reject fraction (14) is arranged in flow direction of the grain (10) downstream of the colour-sorting device (1), characterized in that a cleaning device (3) for cleaning unsorted grain (16) is arranged upstream of the colour-sorting device (1).

10. The apparatus according to claim 9, wherein the size-sorting device (2) is formed as a thickness-sorting device (4), in particular a drum grader (9).

11. The apparatus according to claim 9 or 10, wherein the cleaning device (3) is formed as an air-separation device (6) for separation of unsorted grain (16) at least into grain (10) and contaminants (17).

12. The apparatus according to one of claims 9 to 11, comprising, upstream of the colour-sorting device (1) and in particular upstream of the cleaning device (3), a hulling device (5) for hulling of raw grain (18).

13. The apparatus according to one of claims 9 to 12, comprising conveyance means (7), in particular for the first colour-fraction (11) or the second colour-fraction (12) not conveyed into the size-sorting device (2), for conveying at least the size-reject fraction (14) into the hulling device (5).

14. The apparatus according to one of claims 9 to 13, comprising further conveyance means (8) for combining at least the size-accept fraction (13) with the first colour-fraction (11) or the second colour-fraction (12) not conveyed into the size-sorting device (2) into a further accept-fraction (15) for further processing.

15. Method for upgrading an apparatus comprising a colour-sorting device (1) for sorting grain (10) according to colour and a size-sorting device (2) for sorting colour-sorted grain according to size, wherein the size-sorting device (2) is arranged in flow direction of the grain (10) downstream of the colour-sorting device (1), characterized by the step of arranging a cleaning device (3) for cleaning unsorted grain (16) upstream of the colour-sorting device (1), in particular for forming an apparatus according to one of claims 9 to 14, in particular for performing a method according to one of claims 1 to 8.
